(19) United States
(12) Patent Application Publication
(10) Pub. No.: US 2010/0246906 A1
(43) Pub. Date: Sep. 30, 2010

(54) FACE RECOGNITION

(75) Inventors: Brian Lovell, Queensland (AU); Ting Shan, Queensland (AU)

Correspondence Address: SNELL & WILMER LLP (OC), 600 ANTON BOULEVARD, SUITE 1400, COSTA MESA, CA, 92626, US

(73) Assignee: National ICT Australia Limited, Eveleigh, NSW (AU)

(21) Appl. No.: 12/601,167

(22) PCT Filed: May 29, 2008
(86) PCT No.: PCT/AU08/00760

§ 371 Date: May 7, 2010

(30) Foreign Application Priority Data
Jun. 1, 2007 (AU) 2007902984

(51) Int. Cl. G06K 9/00

(52) U.S. Cl. 382/118

(57) ABSTRACT

This invention concerns computer based face recognition. A person's face is captured in an image and received (12) by a computer (30). The computer operates to estimate the orientation of the face (14). Then using a correlation model, the pose effect is removed from the image that is now represented as pose independent features (16). Pattern recognition techniques are then applied (18) to compare the pose independent features to a gallery stored in memory (18) to match the face to a member of the gallery. The invention offers greater accuracy and can be performed in real time. Aspects of the invention includes a method, software and a computer system.

### TECHNICAL FIELD

This invention concerns face recognition, and in particular a computer method for performing face recognition. In further aspects the invention concerns software to perform the method and a computer system programmed with the software.

### BACKGROUND ART

Face recognition is becoming increasingly important, particularly for security purposes such as automatically providing or denying access.

Most face recognition techniques only work well under quite constrained conditions. In particular, the illumination, facial expressions and head pose must be tightly controlled for good recognition performance. Among the nuisance variations, pose variation is the hardest to model.

An earlier invention by the same inventors is a method for facial feature processing described in International (PCT) application PCT/2007/001169. This method comprises the steps of:
Capturing an image including a face in any pose.
Applying a face detecting algorithm to the image to find the location of the face in the image.
Applying an Active Appearance Model (AAM) to interpret the face located in the image.
Estimating the horizontal and vertical orientation of the face.
And subsequently synthesizing a view of the face from another angle.

This earlier invention proved to be able to improve recognition accuracy by up to about 60%.

### DISCLOSURE OF THE INVENTION

The present invention is a method for face recognition, comprising the steps of:
receiving an image including a face in a pose;
performing an Active Appearance Model (AAM) search on the image to estimate the orientation of the face;
applying a correlation model to remove a pose effect and representing the face as pose independent features, then,
applying pattern recognition techniques to compare the pose independent features to a gallery to match the face to a member of the gallery.

Although the present invention is in some ways similar to the earlier invention there are several important distinctions. First, and most importantly, the present invention does not end with a synthesis of a frontal view. And, further processing is different in each case. This technique may deliver accuracy of up to about 70%.

The present invention may use Active Shape Models (ASM) which is a shorter version of AAM.

The pose independent features may be represented as a vector made up of parameters.

The pattern recognition techniques may involves measuring the similarity between the pose independent features of the face and pose independent features of gallery images.

The present invention may make use of pattern recognition techniques such as Mahalanobis or Cosine measure for classification.

The step of determining the orientation of the face may comprise determining the vertical and horizontal orientation of the face. This forms the basis for the pose angle of the face.

The step of removing the orientation of the face may comprise use of regression techniques.

The gallery may be comprised of pose independent features that each represent one member of the gallery. There may be only one independent feature of each member of the gallery. It is an advantage of at least one embodiment of the invention that multiple images of each member of the gallery with their face in different poses is not required.

The step of receiving the image may comprise capturing the image.

The method may be performed in real time.

In further aspects the present invention may extend to software to perform the method.

In yet a further aspect the present invention provides computer system (hardware) programmed with the software to perform the method described above. The computer system may comprise:
input means to receive an image of a face in a pose;
memory to store a gallery of faces;
a processor operable to perform an Active Appearance Model (AAM) search on the image to estimate the orientation of the face, to apply a correlation model to remove a pose effect and to represent the face as pose independent features, and to apply pattern recognition techniques to compare the pose independent features to the gallery to match the face to a member of the gallery.

### BRIEF DESCRIPTION OF THE DRAWINGS

An example of the process of the invention will now be described with reference to the accompanying drawings, in which:

FIG. 1 is a flow chart of the process of an example of the present invention.

FIG. 3 is a bar chart comparing accuracy of recognition using six different techniques across the angle from left 25 degree to right 25 degree on a database, including the present invention.

FIG. 4 is another bar chart showing the average recognition result of the six recognition methods of FIG. 3.

### BEST MODES OF THE INVENTION

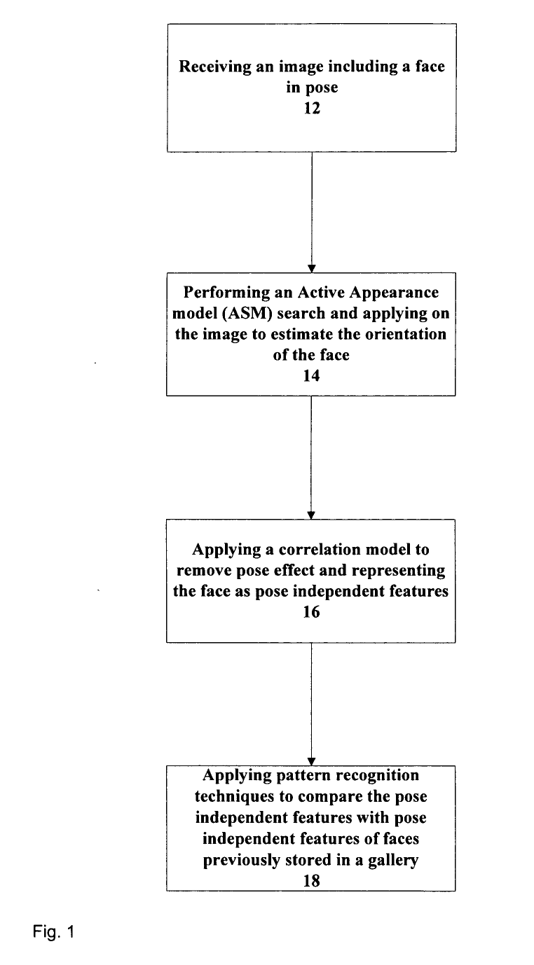

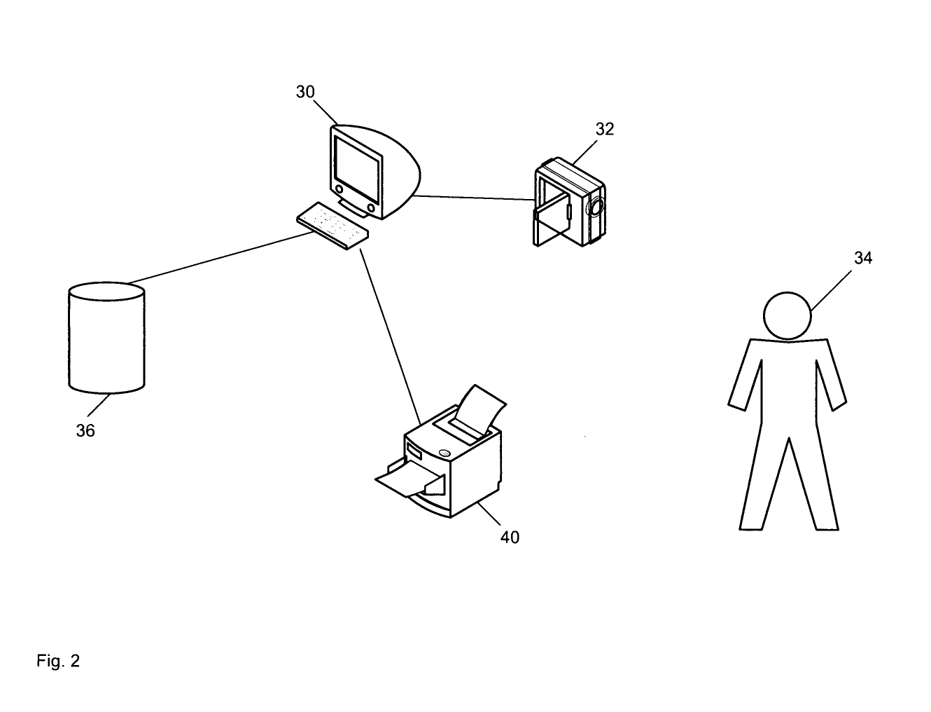

Referring first to FIG. 1, a method for face recognition 10 according to this example is shown. The first step is to capture an image including a face 12. The face may be facing the camera or any pose angle to the vertical or horizontal axes. A pose angle to the vertical axis represents head turning, whereas a pose angle the horizontal represents nodding. A fixed video camera may be used for this purpose.

The next step involves a computer performing an Active Appearance Models (AAM) search and applying regression techniques 14 to first estimate angles representing the horizontal and vertical orientations of the face.

Further processing then involves applying a correlation model to remove any pose effect 16 so that the pose independent features of the face can be represented as a vector of parameters.

Finally, the processing applies pattern recognition techniques to compare the face with faces previously stored in a gallery 18, in order to see whether a match with a member of the gallery can be made. If a match is made the face is recognised.

The method may be performed in real time on a computer having application software installed to cause the computer to operate in accordance with the method. Referring to FIG. 2, the computer system of this example is comprised on a personal computer 30. The computer 30 has memory to store the software and a processor to execute the method. The computer 30 also has input means typical of a personal computer, such as a keyboard and a mouse.

The image of the person's face 34 is captured on a camera 32 of the system, either a still or video camera. This is received as input to the computer 30, such as by direct connection to an input port, over a local computer network (not shown) or over the internet (not shown). This image is processed according to steps 14, 16 and 18 described above. The representation of the captured face as pose independent features may also be stored in the memory of the computer 30. The gallery of images is stored in a database on memory 36 external to the computer 30, again by either direct connection, over a computer network (not shown) or over the Internet. Each record in the database corresponds to a member and comprises an image of the member's face and personal details.

The result of 18 may be displayed on the monitor of the computer 30 or printed on a printer 40. This may show the image as captured, the image of the member that matched the captured face, together with the corresponding personal details.

Each stage of the process will now be described in greater detail under the following subheadings:

### Facial Feature Interpretation Using AAM

Given a collection of training images for a certain object class where the feature points have been manually marked, a shape and texture can be represented by applying Principal Component Analysis (PCA) to the sample shape distributions as:

x= x̅+Qₛc

g= g̅+Q_{g}c

where x̅ is the mean shape, g̅ is the mean texture and Qₛ, Q_{g} are matrices describing the respective shape and texture variations learned from the training sets. The parameter, c, is used to control the shape and texture change.

### Pose Estimation Using Correlation Models

The model parameter c is related to the viewing angle, θ, approximately by a correlation model:

c=c₀+c_{c} cos(θ)+cₛ sin(θ)

where c₀, c_{c} and cₛ are vectors which are learned from the training data. This considers only head turning, but nodding can be dealt with in a similar way.

For each of the image labelled with pose θ in the training set, the process performs Active Appearance Models (AAM) search to find the best fitting model parameters cᵢ, then c₀, c_{c} and cₛ can be learned using regression from the vectors {cᵢ} and vectors {(1, cos θᵢ, sin θᵢ)′}.

Given a new face image with parameters c, the process can estimate orientation as follows. The process first transforms c=c₀+c_{c} cos(θ)+cₛ sin(θ) to:

$$c - {c}_{0} = ( {c}_{c} {c}_{s} ) ( \begin{matrix}cos θ \\ sin θ\end{matrix} )$$

let R_{c}⁻ be the left pseudo-inverse of the matrix (c_{c}|cₛ), then it becomes

$${R}_{c}^{- 1} ( c - {c}_{0} ) = ( \begin{matrix}cos θ \\ sin θ\end{matrix} )$$

Let (x_{α}, y_{α})′=R_{c}⁻(c−c₀), then the best estimate of the orientation is

θ=tan⁻¹(y_{α}/x_{α})

### Removing Pose Effect in Appearance

After the process acquires the angle θ, the correlation model is used to remove pose effect. The equation c₀+c_{c} cos(θ)+cₛ sin(θ) represents the standard parameter vector at pose θ, note that its fixed at specific angle θ and changes when pose changes. Let c_{feature} be the feature vector which is generated by removing the pose effect from the correlation model by

c_{feature}=c−(c₀+c_{c} cos(θ)+cₛ sin(θ))

Given any face image, the process can use Active Appearance Model (AAM) to estimate face model parameters c and use the correlation model as described above to remove the pose effect. Each face image then can be characterized by c_{feature}, which is pose independent.

### Face Recognition Using “Pose-Independent Features”

Both the gallery face images and the given unknown face image can be represented by parameter vector c_{feature}. Recognizing a given face image is a problem of measuring the similarity between the parameter vector of the given face image and the vectors of the gallery images stored in the database. In experiments two different pattern recognition techniques were used: Mathalanobis distance and cosine measure for classification; these are described in detail below.

### Mahalanobis Distance

Mahalanobis distance is a distance measure method which was first introduced by P. C. Mahalanobis in 1936. It is a useful tool to measure the similarity between an unknown sample to a known one. It differs from Euclidean distance in that it takes into account the variability of the data set. Mahalanobis distance can be defined as

d(\vec{x},\vec{y})={square root over ((\vec{x}−\vec{y})^{T}Σ⁻¹(\vec{x}−\vec{y})))}

where \vec{x} and \vec{y} are two vectors of the same distribution with the covariance matrix Σ.

### Cosine Measure

Cosine measure is a technique that tries to measure the angle between different classes respecting to the origin. Cosine measure can be described as the equation:

$$S ( X , Z ) = \frac{{X}^{′} Z}{\vert X \vert \cdot \vert Z \vert}$$

where X and Z are two vectors, Larger angle of two vectors represents larger separation of two classes.
Results for High Angle Faces from Experiments

Using the face model and trained correlation model the process was applied using pose-independent feature on a database to compare the performance of various methods of synthesis APCA or synthesis PCA. Each face image is represented by c_{feature} of 43 dimensions. Both Mahalanobis distance and Cosine Measure were tried for classification.

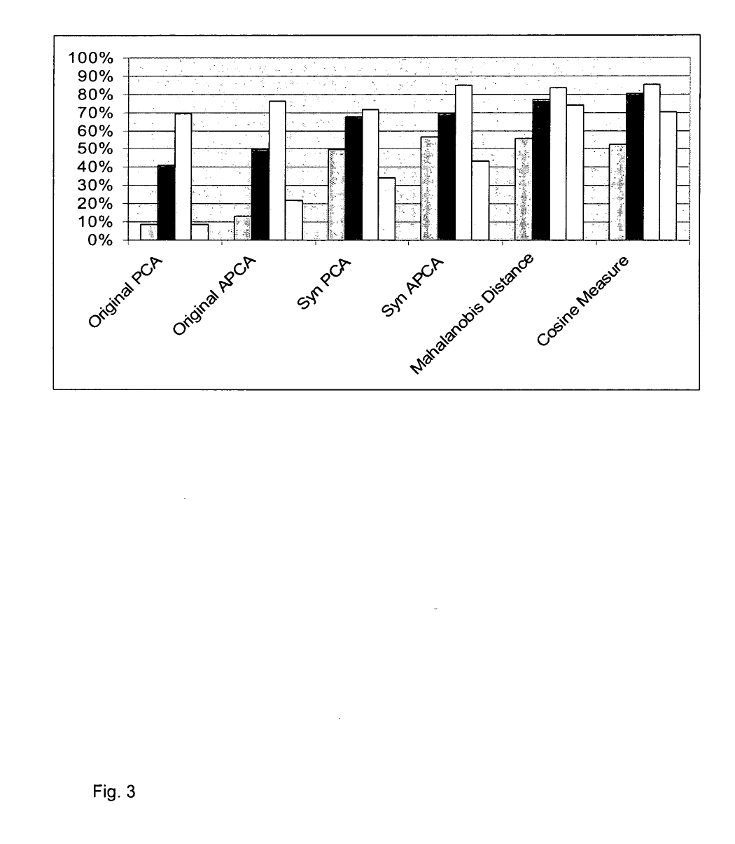

FIG. 3 shows the recognition result using original PCA, original APCA, Synthesized PCA, Synthesized APCA, and the present invention's pose-independent features using by Mahalanobis distance and Cosine measure across the angle from left 25 degree to right 25 degree on Feret Database from the Information Technology Laboratory (see http://www.itl.nisit.gov/iad/humanid/feret).

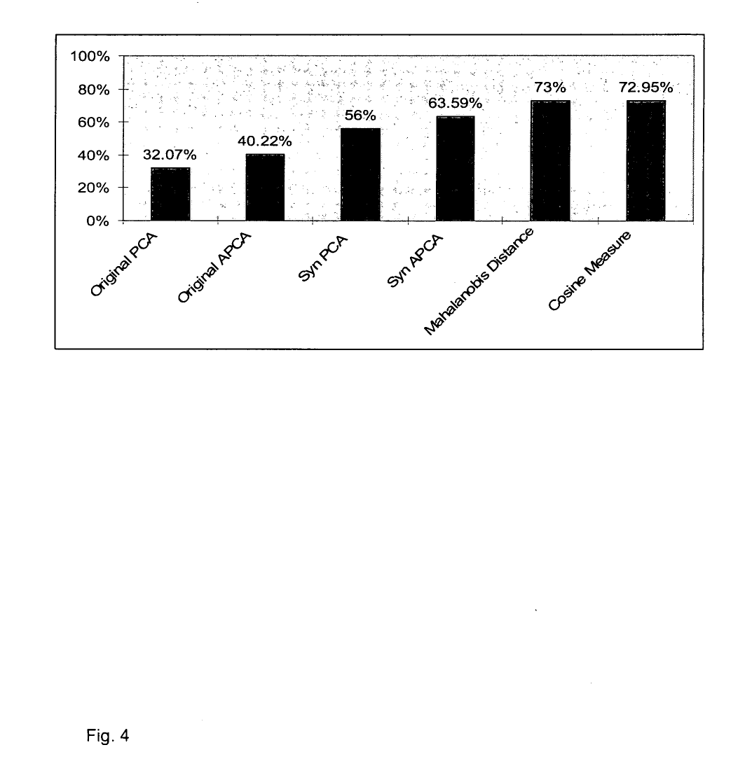

And FIG. 4 shows the average recognition result of these six recognition methods.

From the recognition results in FIGS. 3 and 4, it can be seen that the present process, which makes use of pose-independent features in combination with either Mahalanobis distance or Cosine measure, can reach a higher recognition result than PCA, Synthesized PCA and Synthesized APCA. Additionally, synthesized APCA or synthesized PCA uses a model parameter estimation, synthesis and recognition processing. In contrast the present process by using pose-independent features is able to use a model parameter estimation and recognition processing, which obviates the synthesis step. In this way, the present process by using pose-independent features leads to a very fast multi-view face recognition approach.

Results for Frontal Faces from Experiments

To evaluate the performance of recognition by measuring pose-independent features on frontal faces, a dataset is formed by randomly selecting 200 frontal face images from the Feret Database (NIST 2001). Both APCA and the present process were tested on this dataset. Table 1 shows that APCA can reach 95% recognition rate on the frontal face images, which is the same as reported earlier (Chen and Lovell 2004; Lovell and Chen 2005); and the present process which measures the pose-independent feature by Mahalanobis distance and Cosine Measure can both reach 98% recognition rate, which shows that this process is also robust to frontal faces.

TABLE 1
Recognition rate of APCA, pose-independent feature measured by
Mahalanobis distance and Cosine Measure on frontal faces.

| | | Mahalanobis | Cosine |
|---|---|---|---|
| Method | APCA | Distance | Measure |
| Recognition Rate | 95% | 98% | 98% |

The invention can be applied to security applications, such as seeking to identify a person whose face is captured by a camera. Other applications include searching a set of photographs to automatically locate images (still or video) that include the face of a particular person. Further, the invention could be used to automatically organise images (still or videos) into groups where each group is defined by the presence of a particular person or persons face in the captured image.

Although the invention has been described with reference to a particular example, it should be appreciated that it could be exemplified in many other forms and in combination with other features not mentioned above.

1. A method for face recognition, comprising the steps of:
receiving an image including a face in a pose;
performing an Active Appearance Model (AAM) search on the image to estimate the orientation of the face;
applying a correlation model to remove a pose effect and representing the face as pose independent features; then,
applying pattern recognition techniques to compare the pose independent features to a gallery to match the face to a member of the gallery.

2. A method according to claim 1, wherein the Active Shape Models (ASM) wis the type of Active Appearance Model (AAM) used.

3. A method according to claim 1, wherein the pose independent features are represented as a vector made up of parameters.

4. A method according to claim 1, wherein the pattern recognition techniques involve measuring the similarity between the pose independent features of the face and pose independent features of gallery images.

5. A method according to claim 1, wherein the pattern recognition techniques is Mahalanobis or Cosine measure.

6. A method according to claim 1, wherein the step of determining the orientation of the face comprises determining the vertical and horizontal orientation of the face.

7. A method according to claim 1, wherein the step of removing the orientation of the face comprises use of regression techniques.

8. A method according to claim 1, wherein the gallery is comprised of pose independent features that each represent one member of the gallery.

9. A method according to claim 1, wherein the step of receiving the image comprises capturing the image.

10. A method according to claim 1, the method is being performed in real time.

11. Software, that when installed on a computer causes it to operate to perform the method of claim 1.

12. A computer system to perform facial recognition comprising:
input means to receive an image of a face in a pose;
memory to store a gallery of faces;
a processor operable to perform an Active Appearance Model (AAM) search on the image to estimate the orientation of the face, to apply a correlation model to remove a pose effect and to represent the face as pose independent features, and to apply pattern recognition techniques to compare the pose independent features to the gallery to match the face to a member of the gallery.
